(19) United States
(12) Patent Application Publication
(10) Pub. No.: US 2026/0208582 A1
(43) Pub. Date: Jul. 23, 2026

(54) Compact Head-up Display Having a Direction-Dependent Diffuser for Suppressing a Parasitic Image

(71) Applicant: Bayerische Motoren Werke Aktiengesellschaft, Muenchen (DE)

(72) Inventor: Sebastian Takeshi LAMPEN, Minato City, Tokyo (JP)

(21) Appl. No.: 19/144,584

(22) PCT Filed: Mar. 18, 2024
(86) PCT No.: PCT/DE2024/100225

§ 371 Date: Jun. 30, 2025

(30) Foreign Application Priority Data
Mar. 23, 2023 (DE) 10 2023 107 275.7

(51) Int. Cl. B60K 35/231; B60K 35/60; G02B 5/02; G02B 27/01

(52) U.S. Cl. CPC B60K 35/231; B60K 35/60; G02B 5/0278; G02B 27/0101; B60K 2360/31; B60K 2360/693; G02B 2027/012; G02B 2027/015; G02B 2027/0196

(57) ABSTRACT

A compact projection unit for a field-of-view display device for a vehicle includes an imaging unit for creating a light beam with display content; a deflection element so that the light beam leaves the projection unit in a predetermined exit direction to be subsequently reflected by a reflection pane arranged in the field of view of a user to the eye box of the user and thereby present the user with the display content in the form of a virtual image behind the reflection pane; and a cover pane in the beam path of the exiting light beam which closes off the projection unit to the outside has direction-dependent transmission and scattering properties such that it is transparent to the exiting light beam and diffusely scatters interference path directions which lead to the cover pane directly from the imaging unit or optical elements other than the deflection element.

### BACKGROUND AND SUMMARY

The invention relates to a projection unit for a field-of-view display device, which is also known under the designation head-up display (HUD) and can be used in particular in a motor vehicle or another land vehicle, aircraft, or watercraft. Field-of-view display devices of this type are designed to generate a virtual image inserted into the field-of-view of a user via reflection on a vehicle window, in particular a windshield, or on a separate combiner plate provided for this purpose, which is arranged in the field-of-view of the user. The invention is also directed to such a field-of-view display device and to a vehicle equipped therewith.

In particular for motor vehicles, overlaying display content such as specifications about speed limits or other useful navigation and vehicle operation notifications in the form of a virtual image on the real surroundings image observed by the driver in front of the vehicle by way of a head-up display is known, so that the driver does not have to look away from the road to read this display. To generate the display content, an HUD in classic design comprises a projection unit (cf. FIG. 1a) housed below the windshield in the interior of the instrument panel. This projection unit typically contains a display for generating a light beam bundle having desired display content and a suitable imaging and projection optical unit to form the generated light beam bundle and guide it onto the windshield or combiner plate so that it is reflected therefrom to the eyes of the driver and he can thus see the virtual image in a suitable size and distance behind it. In the classic HUD design, the projection optical unit comprises a concave mirror, which is used, among other things, to enlarge the image and the dimensions of which scale linearly with the size of the virtual display area and thus requires significant installation space in the instrument panel of the vehicle. Moreover, the concave mirror is usually embodied as rotatable for adaptation to different user sizes or positions, which requires even more installation space in the vertical direction of the vehicle.

However, this installation space is very limited in a vehicle. In particular, this results in restrictions in the geometric design of a transparent cover plate arranged above the concave mirror, which closes the projection unit or its housing to the outside toward the windshield and thus protects it from interfering influences such as dust and moisture. In general, one will moreover wish to provide the cover plate with a space-occupying concave geometry in the vertical direction of the vehicle to protect the driver from blinding sunlight reflections on its outer side, which is known as “geometric antireflection function”.

A predetermined vertical minimum distance has to be maintained here between the concave mirror and the cover plate. This is motivated by the technical problem that, with a more compact design, interfering light paths would arise which would reach the output light beam bundle outside the regular beam path by reflection of the display light on the lower surface of the cover plate and subsequently on the concave mirror and would thus result in the occurrence of a parasitic image (cf. FIG. 1a).

It is the object of the present invention to specify a projection unit, which is alternative or improved with regard to the required installation space, the implementable sun protection, the display quality, and/or other aspects, for a field-of-view display device. The field-of-view display device is to be suitable in particular for use in a vehicle here.

This object is achieved by a projection unit, by a field-of-view display device containing the projection unit, and by a vehicle equipped therewith according to the claimed invention. All refining features and effects mentioned in the claims and the following description for the projection unit also apply with respect to the field-of-view display device and the vehicle, and also vice versa in each case.

According to a first aspect, a compact projection unit for a field-of-view display device is provided, which is designed to generate a virtual image in the field-of-view of a user and can be used in particular in a vehicle. The field-of-view display device can be designed, for example, as a head-up display (HUD).

The projection unit has an imaging unit (also called picture generating unit, PGU) designed to generate a light beam bundle having desired display content, for which in principle any image generating technology can be used which is suitable in particular for a vehicle. Among other things, it can be a display, for example a flatscreen display or a waveguide display, but also a projector system, such as a DLP projector or a diffusing plate illuminated or scanned using a light beam, and much more.

A deflection element is designed and arranged in the beam path of the light beam bundle such that the light beam bundle deflected thereby leaves the projection unit in a predetermined exit direction in order to subsequently be reflected from a reflection plate arranged in the field-of-view of the user to his eye box and to thus display the display content to the user in the form of a virtual image behind the reflection plate. It can be, for example, a reflective or refractive deflection element of any suitable type which can also be equipped with further optical functions in addition to the beam deflection if needed.

As is typical, the eye box of the field-of-view display device is understood herein as a two-dimensional or three-dimensional spatial area from which the virtual image is unrestrictedly visible for the user. The reflection plate can be formed, for example, by a section of a vehicle window or by a combiner plate provided as an extra feature. It is thus a component part of the field-of-view display device specified below, but is not necessarily also a component part of the projection unit, which can also be produced and sold without it if the vehicle window is used, for example. In the case of a combiner plate provided as an extra feature, it can also be integrated in a known manner in the projection unit (for example, foldable in/out).

A cover plate (also called cover glass), which closes the projection unit or possibly its housing to the outside, so that the optical unit and electronics unit in the interior of the projection unit are protected from external interfering influences such as dust and moisture, extends in the beam path of the light beam bundle emerging from the projection unit transversely to its exit direction. The cover plate is designed here having predetermined direction-dependent transmission and scattering properties such that it is substantially transparent for the entire emerging light beam bundle, which is supposed to contribute to generating the virtual image, and is not reflective for interfering path directions, which lead directly from the imaging unit or other optical elements except for the mentioned deflection element to the cover plate and ideally is also not transmitting, but rather diffusely scattering. In other words, the cover plate is designed as a direction-dependent diffuser, which transmits nearly without loss only in an angle of incidence range predetermined for the emerging light beam bundle and is diffusely scattering for angles of incidence from other directions.

One concept with this projection unit is to suppress interfering paths which are incident on the cover plate from directions other than the exit direction intended for the light beam bundle from the interior of the projection unit by the use of a direction-dependent diffuser in the cover plate. The cover plate can thus be arranged closer than in the prior art to the other components of the projection unit such as the deflection mirror or the imaging unit, etc., without parasitic images being able to arise due to interference light paths via the reflection on the inner surface of the cover plate. The installation space thus obtained can be used differently, for example to make the cover plate and/or other components of the projection unit larger and/or more mobile and thus to achieve better optical features and/or a larger image size and/or a better sun protection and much more.

In particular, the vertical minimum distance required in conventional HUDs in vehicles between the cover plate and the deflection element such as a concave mirror, which was mentioned at the outset, therefore does not have to be maintained. Instead, a minimum distance between the cover plate and the deflection element and/or between the cover plate and the edge beams of the light beam bundle contributing to generating the virtual image can be minimized solely in consideration of mechanical boundary conditions. The installation space required for the projection unit can thus be optimized (compactness). In particular, more degrees of freedom in the design of the cover plate geometry result in this way, which are also usable for sun protection optimization, in addition to the installation space optimization. The mentioned minimum distance can in particular be a vertical minimum distance in the vertical direction of the vehicle. The spatial orientation terms used herein such as “above”, “below”, “in front of”, “behind”, “horizontally”, “vertically”, etc. always refer in the case of use in the vehicle to the typical vehicle-fixed Cartesian coordinate system having longitudinal, transverse, and vertical directions of the vehicle perpendicular to one another.

The cover plate can be substantially transparent, for example, in a predetermined angle of incidence range of, for example, up to 5° or up to 10° around its transmission axis selected and defined in the production and can be increasingly diffusely scattering for the light generated in the projection unit at angles of incidence rising beyond this. This transmission axis is ideally aligned along the exit direction of the light beam bundle. For directions of incidence outside this angle of incidence range, the cover plate can have, for example, a transmission coefficient which sinks steadily with increasing angle deviation from the transmission axis and a correspondingly increasing scattering characteristic, according to a relationship which is specifically selected and defined in the production of the cover plate. In particular, the cover plate can be largely diffusely scattering and therefore in particular also not reflective for angles of incidence which deviate from the exit direction of the light beam bundle by approximately 10° to approximately 70°, in particular by approximately 20° to approximately 60° or by approximately 30° to approximately 50°.

According to one embodiment, the cover plate is designed as substantially diffusely scattering and therefore not reflective for the interfering light path which leads from the imaging unit directly to the cover plate and, upon a mirror reflection thereon, would reach the beam path of the emerging light beam bundle via a subsequent deflection on the deflection element.

The mentioned deflection element can in particular be a concave mirror, which is designed as image-enlarging and/or image-correcting such that the virtual image appears to the user, for example, in a predetermined size, distance, and/or display quality.

The mentioned exit direction can in particular correspond to a center beam direction of the light beam bundle emerging from the projection unit. The center beam direction of the field-of-view display device is understood as is typical as the direction of a light beam which emerges from a center of the imaging surface or display surface and leads into a center of the eye box.

In particular, an outer surface of the cover plate facing away from the interior of the projection unit can have a predetermined concavely curved geometry, which is designed to deflect interfering ambient light reflections out of the beam path of the light beam bundle output by the projection unit and is also known as a geometric antireflective function. Due to the installation space obtained as described above, more design freedom is available for the optimization of this geometry than in the prior art.

In one specific design, the cover plate can be designed as a plastic plate, the static, non-holographic material structure of which has the mentioned direction-dependent transmission and scattering properties. This material structure can be, for example, a permanent polymer structure which can be generated in the cover plate (i.e. the direction-dependent diffuser) in its production. A predetermined transmission axis, along which it is transparent, and a predetermined angle dependence for the diffuse scattering increasing with the deviation from this direction, can be applied here to the cover plate, for example. In other words, it is a plastic structured in a suitable manner.

Alternatively thereto, the cover plate can comprise a plastic layer or film provided with similar properties, which is applied to a transparent carrier plate (for example, made of glass or plastic) or introduced therein.

According to a further aspect, a field-of-view display device is provided, in particular for use in a vehicle. The field-of-view display device also comprises, in addition to the projection unit presented herein, an above-mentioned reflection plate, which can in particular be at least partially transparent. The reflection plate is arranged/to be arranged in the field-of-view of a user, for example a driver or another occupant of the vehicle, and designed here such that it reflects the light beam bundle to his eye box, by which the display content in the form of a virtual image can be displayed behind the reflection plate and is also displayed in operation of the field-of-view display device.

According to a further aspect, a vehicle, in particular a motor vehicle or any other land vehicle, aircraft, or watercraft is provided. The vehicle has a vehicle window which at least partially delimits a passenger compartment, in particular a windshield, and is equipped with the above field-of-view display device, the projection unit of which is arranged in the passenger compartment and the reflection plate of which is designed as a section of the vehicle window or as a combiner plate arranged in the passenger compartment. For example, the projection unit can be installed directly below an upper side of an instrument panel of the vehicle, such that the light beam bundle is thrown by the projection unit onto the windshield or a combiner plate positioned in front of it in the field-of-view of the driver or another occupant and is reflected therefrom to his eyes.

The above aspects of the invention and the embodiments and specific designs thereof are explained in more detail hereinafter on the basis of examples illustrated in the appended drawings. The drawings are schematic illustrations. They can, but do not have to be understood as to scale and/or faithful to the angles.

### BRIEF DESCRIPTION OF THE DRAWINGS

FIG. 1a shows a vertical longitudinal section of a detail of a motor vehicle having an HUD according to the prior art.

FIG. 1b shows a vertical longitudinal section of a detail of a motor vehicle having a field-of-view display device according to an exemplary embodiment of the invention.

### DETAILED DESCRIPTION OF THE DRAWINGS

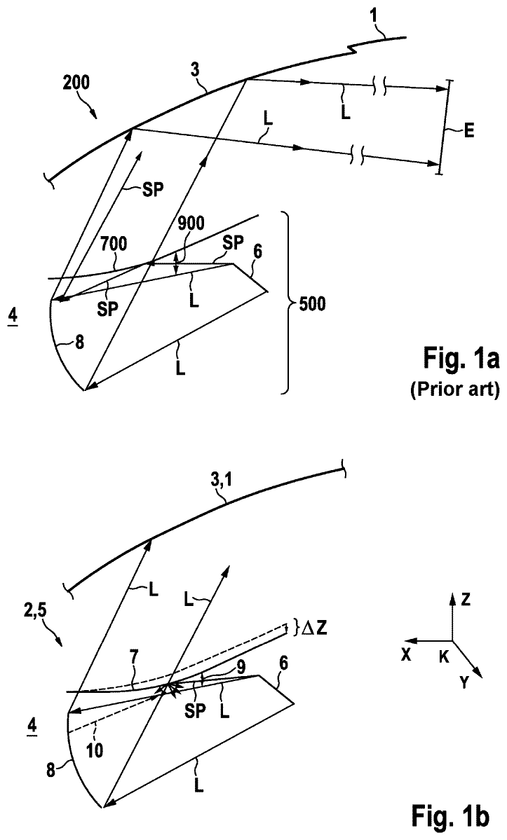

All different embodiments, variants, and specific design features of the projection unit, the field-of-view display device, and the vehicle according to the above aspects of the invention which are mentioned above in the description and in the following claims can be implemented in the example shown in FIG. 1b, in particular also alternatively or additionally to the features shown therein. They are therefore not all repeated once again hereinafter. This also applies accordingly to the term definitions and effects already specified above with respect to individual features which are shown in FIG. 1b.

FIG. 1a shows, for preparatory problem explanation, a detail of a vehicle 1 having a conventional head-up display (HUD) 200 in the classic design mentioned at the outset in a vertical longitudinal section. The HUD 200 is designed to generate a virtual image (not shown) in the field-of-view of a user, for example a driver of the vehicle 1, which is only indicated in FIG. 1a by an eye box E intended for his eyes in the passenger compartment of the vehicle 1. The vehicle 1 is a motor vehicle here solely by way of example. It is indicated in FIG. 1a by its windshield 3 and an instrument panel 4, which extends underneath this and is not shown in more detail.

The HUD 200 comprises a conventional projection unit 500, which is arranged in this example below the windshield 3 in the interior of the instrument panel 4. The projection unit 500 contains an imaging unit 6, in this example a display, designed to generate a light beam bundle L having desired display content. The light beam bundle L is schematically indicated in FIG. 1a by its edge beams, which approximately delimit its beam cross-section required to generate the virtual image. A concave mirror 8 is arranged in the beam path of the generated light beam bundle L in this example, the concavely curved image-enlarging front side of which is designed to throw the light beam bundle L in a suitable shape and direction on the windshield 3, from which it is subsequently reflected to the eye box E. The windshield 3 is therefore used as the reflection surface of the HUD 200 mentioned herein.

The projection unit 500 is protected from any interfering influences such as dust and moisture, etc. toward the windshield 3 by a cover plate 700, which is transparent to the emerging light beam bundle L. This conventional cover plate 700 is manufactured as is typical from glass or transparent plastic and in this example moreover has a concavely curved outer surface for the above-mentioned geometric antireflective function for sunbeams incident from the outside.

In this case, a conventional vertical minimum distance 900 has to be maintained between the cover plate 700 and the upper edge beam of the light beam bundle L shown in FIG. 1a, so that an interference light path SP, which is incident from the imaging unit 6 directly on the lower surface of the cover plate 700 in FIG. 1a and is reflected therefrom in the direction of the concave mirror 8, thus cannot be incident, as indicated in FIG. 1a for illustration, on the concave mirror 8 and can be coupled thereby into the beam path of the light beam bundle L. This is because this would result in an interfering parasitic image component in the virtual image. Therefore, the vertical minimum distance 900 in practice even has to be somewhat greater than dimensioned in FIG. 1a, which substantially restricts the available installation space and therefore also the degrees of freedom in the geometric design of the cover plate 700 and the concave mirror 8. A solution to this problem is described hereinafter with reference to FIG. 1b.

FIG. 1b shows a vertical longitudinal section of a detail of a vehicle 1 having a field-of-view display device 2 according to an exemplary embodiment of the invention, which is designed here solely by way of example as a head-up display (HUD). To avoid repetitions, only the differences from the conventional HUD 200 of FIG. 1a are described hereinafter. The vehicle 1 is also a motor vehicle here solely by way of example, which is indicated similarly to in FIG. 1a by its windshield 3 and an instrument panel 4, which extends underneath and is not shown in more detail. In addition, the typical vehicle-fixed Cartesian coordinate system K having longitudinal, transverse, and vertical directions X, Y, and Z of the vehicle 1 perpendicular to one another is shown, to which the spatial orientation terms such as “above”, “below”, “in front of”, “behind”, “horizontally”, “vertically”, etc. refer.

The field-of-view display device 2 differs from the conventional HUD 200 of FIG. 1a due to the design and arrangement of the cover plate 7 in its projection unit 5. In contrast to the conventional cover plate 700 of FIG. 1a (the position of which is indicated by dashed lines in FIG. 1b), the cover plate 7 is designed as a direction-dependent diffuser, which is nearly completely light-transmissive for the light beam bundle L to be output and is diffusely scattering for interference light paths from directions of incidence which deviate significantly from the intended exit direction. In particular the interference light path SP, which comes directly from the imaging unit 6, can thus be suppressed nearly completely in that it is converted at the cover plate 7 into diffusely scattered light 10 instead of being reflected to the concave mirror 8. Therefore, the vertical minimum distance 9 between the cover plate 7 and the upper edge beam of the light beam bundle L shown in FIG. 1b can be significantly reduced in comparison to FIG. 1a, i.e. solely defined on the basis of mechanical boundary conditions such as the desired mobility of the concave mirror 8, etc. In other words, the cover plate 7, as shown in FIG. 1b, can be reduced in the installation space in this example by a height amount ΔZ of approximately 5 to 6 cm in comparison to the conventional cover plate 700. This installation space can therefore be used differently, for example for additional optimization of other components of the projection unit 5, in order to achieve better imaging features, image size, and/or antireflective function than would be possible in FIG. 1a.

### LIST OF REFERENCE SIGNS

1 vehicle
200 conventional HUD
2 field-of-view display device
3 windshield
4 instrument panel
500 conventional projection unit
5 projection unit
6 imaging unit
700 conventional cover plate
7 cover plate
8 concave mirror
900 conventional minimum distance
9 minimum distance
10 scattered light
L light beam bundle
E eye box
ΔZ height amount
K vehicle-fixed Cartesian coordinate system
X, Y, Z longitudinal, transverse, and vertical directions of the vehicle

1.-9. (canceled)

10. A projection unit for a field-of-view display device for a vehicle, the projection unit comprising:
an imaging unit configured to generate a light beam bundle having desired display content;
a deflection element arranged in a beam path of the light beam bundle and configured such that the light beam bundle departs the projection unit in a predetermined exit direction, to subsequently be reflected from a reflection plate arranged in a field-of-view of a user to an eye box of the user and to thus display the display content to the user in a form of a virtual image behind the reflection plate; and
a cover plate, which extends in a beam path of the emerging light beam bundle transversely to its exit direction and closes the projection unit to an outside and protects the projection unit;
wherein the cover plate has predetermined direction-dependent transmission and scattering properties such that the cover plate essentially transparent to the emerging light beam bundle and is essentially diffusely scattering for interference path directions, which lead directly from the imaging unit or optical elements other than the deflection element to the cover plate.

11. The projection unit according to claim 10, wherein:
a minimum distance between the cover plate and the deflection element and/or between the cover plate and edge beams of the light beam bundle contributing to generating the virtual image is minimized solely in consideration of mechanical boundary conditions.

12. The projection unit according to claim 10, wherein:
the cover plate is essentially diffusely scattering and therefore not reflective for an interference light path which leads from the imaging unit directly to the cover plate and, upon a mirror reflection on the cover plate, would reach the beam path of the emerging light beam bundle via a subsequent deflection on the deflection element.

13. The projection unit according to claim 10, wherein:
the deflection element is configured as an image-enlarging and/or error-correcting concave mirror.

14. The projection unit according to claim 10, wherein:
an outer surface of the cover plate facing away from an interior of the projection unit has a predetermined concavely curved geometry, which is configured to guide ambient light reflections out of the beam path of the light beam bundle output by the projection unit.

15. The projection unit according to claim 10, wherein:
the cover plate is configured as a plastic plate, a static, non-holographic material structure of which has the direction-dependent transmission and scattering properties.

16. The projection unit according to claim 10, wherein:
the cover plate comprises a transparent carrier plate having a plastic layer or film applied on the transparent carrier plate or introduced in the transparent carrier plate; and
the plastic layer or film has a static, non-holographic material structure having the direction-dependent transmission and scattering properties.

17. A field-of-view display device for use in a vehicle, the field-of-view display device comprising:
the projection unit according to claim 10; and
a reflection plate which is arranged in the beam path of the light beam bundle output by the projection unit and is at least partially transparent;
wherein the reflection plate is arranged in the field-of-view of the user and configured such that the reflection plate reflects the light beam bundle to the eye box predetermined for the user, due to which the display content can be displayed to the user in a form of a virtual image behind the reflection plate.

18. A vehicle having longitudinal, transverse, and vertical directions of a vehicle-fixed Cartesian coordinate system perpendicular to one another, the vehicle comprising:
a vehicle window, which at least partially delimits a passenger compartment; and
the field-of-view display device according to claim 17, wherein the projection unit is arranged in the passenger compartment, and the reflection plate is configured as a section of the vehicle window or as a combiner plate arranged in the passenger compartment.

19. The projection unit according to claim 18, wherein the vehicle window is a windshield.

20. The projection unit according to claim 18, wherein the projection unit is arranged in an interior of an instrument panel arranged below the windshield.
